(19) United States
(12) Patent Application Publication
(10) Pub. No.: US 2012/0127749 A1
(43) Pub. Date: May 24, 2012

(54) SIDE-LIGHT TYPE BACKLIGHT MODULE WITH LOCAL HEAT-DISSIPATION ENHANCEMENT

(75) Inventors: Yicheng Kuo, Shenzhen (CN); Lindong Fang, Shenzhen (CN)

(73) Assignee: Shenzhen China Star Optoelectronics Technology Co.Ltd, Shenzhen Guangdong (CN)

(21) Appl. No.: 13/000,912

(22) PCT Filed: Nov. 26, 2010
(86) PCT No.: PCT/CN2010/079166

§ 371 Date: Dec. 22, 2010

(30) Foreign Application Priority Data
Nov. 18, 2010 (CN) 201010553851.0

(51) Int. Cl. F21V 29/00

(52) U.S. Cl. 362/600

(57) ABSTRACT

The present invention discloses a side-light type backlight module with local heat-dissipation enhancement. The backlight module is provided with a local heat-dissipation enhancement region on a portion of the back plate close to at least one light input side edge, and a surface of the local heat-dissipation enhancement region has a thermal-conductivity enhancement coating and a three-dimensional heat-dissipation profile, so that the temperature can be rapidly distributed to an even degree and lowered down, and the heat exchange area can be increased. Thus, the side-light type backlight module with local heat-dissipation enhancement of the present invention can efficiently prevent from affecting the chromaticity and brightness of a light emitting device due to the high temperature, so as to improve the uniformity of the chromaticity and brightness of an entire liquid crystal display (LCD) module and enhance the light extraction efficiency thereof.

### FIELD OF THE INVENTION

The present invention relates to a side-light type backlight module with local heat-dissipation enhancement, and more particularly to a side-light type backlight module having a thermal-conductivity enhancement coating and a three-dimensional heat-dissipation profile for local heat-dissipation enhancement.

### BACKGROUND OF THE INVENTION

A liquid crystal display (LCD) is a type of flat panel display (FPD), which shows images by the property of liquid crystal material. Comparing with other display devices, the liquid crystal display has advantages in lightweight, compactness, low driving voltage and low power consumption, and thus has already become the mainstream product in the whole consumer market. However, the liquid crystal material of the liquid crystal display cannot emit light by itself, and must depend upon an external light source. Thus, the liquid crystal display further has a backlight module to provide the needed light source.

Generally, the backlight module can be divided into two types, i.e. the side-light type backlight module and the direct-light type backlight module. Traditional backlight modules mainly use cold cathode fluorescent lamps (CCFLs), hot cathode fluorescent lamps (HCFLs) or light emitting diodes (LEDs) as light sources.

Referring now to FIG. 1, FIG. 1 is a partially cross-sectional side view of a traditional side-light type backlight module. A side-light type backlight module 90 comprises a back plate 91, and at least one side edge of the back plate 91 is formed with at least one side wall 911, and a central portion of the back plate 91 supports a light guide plate 92. The light guide plate 92 is provided with an optical film assembly 93 thereon, and a housing 94 is covered on outer edges of the back plate 91 for mounting the optical film assembly 93 and the light guide plate 92 from top to bottom, in order to construct the side-light type backlight module 90. Furthermore, the side-light type backlight module 90 can be further stacked with a liquid crystal panel 80 (as shown by imaginary line), and an outer frame 70 (as shown by imaginary line) covers and positions the liquid crystal panel 80 and the side-light type backlight module 90, so as to construct a liquid crystal display (LCD) (unlabeled).

As shown in FIG. 1, an inner surface of the side wall 911 of the back plate 91 of the side-light type backlight module 90 is provided with a light source assembly 95, wherein the light source assembly 95 has at least one light emitting device 951, and the light emitting device 951 can be an LED light emitting device which has a light source direction directing toward the light guide plate 92. The light emitting device 951 is generally mounted on the side wall 911 by screw connection or thermal conductive tape attachment. The light source assembly 95 will generate heat during operation, and the heat can be transferred downward through the side wall 911 and then transferred inward to the central portion of the back plate 91 along the direction of arrows in figure, so as to dissipate the heat.

Referring now to FIG. 2, FIG. 2 is a partially cross-sectional side view of another traditional side-light type backlight module. A side-light type backlight module 90 of FIG. 2 is similar to the side-light type backlight module 90 of FIG. 1, and the difference therebetween is that: the side-light type backlight module 90 of FIG. 2 is further provided with a thermal conductive block 96 between the light source assembly 95 and the back plate 91, wherein the thermal conductive block 96 is about L-shape and attached to the back plate 91 and the side wall 911 thereof, and the thermal conductive block 96 is generally made of aluminum (Al) based material and formed by an extrusion process. Because the Al-based thermal conductive block 96 has better thermal conductivity and the contact area between the Al-based thermal conductive block 96 and back plate 91 is increased, heat generated by the light source assembly 95 can be speedily transferred from the side wall 911 to the central portion of the back plate 91, so as to dissipate the heat.

However, the foregoing two traditional side-light type backlight modules 90 still have one problem, as follows: during the heat is dissipated by the back plate 91, a region of the back plate 91 close to the light source assembly 95, i.e. a region of the back plate 91 adjacent to the side wall 911 (i.e. a region of the back plate 91 corresponding to the lower arrow), has a certain length and thus has a phenomenon of uneven temperature distribution, wherein a relatively central portion of this region of the back plate 91 has a higher temperature, while two relatively edge portions thereof has a lower temperature. That is, the relatively central portion of this region of the back plate 91 will generate a phenomenon of thermal aggregation which will deteriorate the heat-dissipation efficiency of the light emitting device 951 of the light source assembly 95 close to the central portion. As a result, the light emitting device 951 (i.e. LED) is affected by high temperature to cause the uneven chromaticity and brightness thereof, and thus the brightness and chromaticity of the entire liquid crystal display is also uneven, resulting in the visual effect of products for customers.

As a result, it is necessary to provide a side-light type backlight module with local heat-dissipation enhancement to solve the problems existing in the conventional technologies, as described above.

### SUMMARY OF THE INVENTION

A primary object of the present invention is to provide a side-light type backlight module with local heat-dissipation enhancement, wherein a position of a back plate close to a light input side edge is provided with a local heat-dissipation enhancement region, and a surface of the local heat-dissipation enhancement region has a thermal-conductivity enhancement coating. Because the thermal-conductivity enhancement coating has a greater thermal diffusion coefficient to rapidly distribute the temperature to an even degree to thus lower the temperature, it can efficiently prevent from affecting the chromaticity and brightness of a light emitting device due to the temperature, so as to improve the uniformity of the chromaticity and brightness of an entire liquid crystal display (LCD) module and enhance the light extraction efficiency thereof.

A secondary object of the present invention is to provide a side-light type backlight module with local heat-dissipation enhancement, wherein the local heat-dissipation enhancement region has a three-dimensional heat-dissipation profile for increasing the heat exchange area, so that the temperature can be rapidly diffused into the ambient air through natural air convection.

To achieve the above object, the present invention provides a side-light type backlight module with local heat-dissipation enhancement, wherein the side-light type backlight module comprises a back plate and at least one light source assembly, the back plate has at least one light input side edge, and the at least one light source assembly is close to the at least one light input side edge, a portion of the back plate close to the at least one light input side edge is formed with a local heat-dissipation enhancement region, and a surface of the local heat-dissipation enhancement region has a thermal-conductivity enhancement coating.

In one embodiment of the present invention, material of the thermal-conductivity enhancement coating has a thermal diffusion coefficient greater than that of base material of the back plate.

In one embodiment of the present invention, the thermal-conductivity enhancement coating is a copper (Cu) coating; the base material of the back plate is aluminum (Al) or alloy thereof.

In one embodiment of the present invention, the surface of the local heat-dissipation enhancement region has a three-dimensional heat-dissipation profile.

In one embodiment of the present invention, the three-dimensional heat-dissipation profile is wavy.

In one embodiment of the present invention, at least a central portion of the back plate close to the light input side edge has the local heat-dissipation enhancement region. The length of the local heat-dissipation enhancement region is equal to or greater than one-third of the length of the light input side edge.

In one embodiment of the present invention, the at least one light input side edge of the back plate is vertically extended to form at least one light input side wall, and the local heat-dissipation enhancement region is extended onto the at least one light input side wall.

To achieve the above object, the present invention provides another side-light type backlight module with local heat-dissipation enhancement, wherein the side-light type backlight module comprises a back plate and at least one light source assembly, the back plate has at least one light input side edge, and the at least one light source assembly is close to the at least one light input side edge, a portion of the back plate close to the at least one light input side edge is formed with a local heat-dissipation enhancement region, and a surface of the local heat-dissipation enhancement region has a three-dimensional heat-dissipation profile.

The side-light type backlight module with local heat-dissipation enhancement of the present invention is provided with the local heat-dissipation enhancement region on the portion of the back plate close to the light input side edge, and the surface of the local heat-dissipation enhancement region has the thermal-conductivity enhancement coating and/or the three-dimensional heat-dissipation profile. The thermal diffusion coefficient of the thermal-conductivity enhancement coating is greater to rapidly distribute the temperature to an even degree and diffuse outward, while the three-dimensional heat-dissipation profile can increase the heat exchange area with the ambient air, so that the temperature can be rapidly diffused into the ambient air through natural air convection. Thus, the present invention can efficiently prevent from affecting the chromaticity and brightness of a light emitting device due to the high temperature, so as to improve the uniformity of the chromaticity and brightness of an entire liquid crystal display (LCD) module and enhance the light extraction efficiency thereof.

### DESCRIPTION OF THE DRAWINGS

FIG. 1 is a partially cross-sectional side view of a traditional side-light type backlight module;

FIG. 2 is a partially cross-sectional side view of another traditional side-light type backlight module;

FIG. 3 is an exploded perspective view of a side-light type backlight module with local heat-dissipation enhancement according to a first embodiment of the present invention;

FIG. 4 is a perspective view of a back plate of the side-light type backlight module with local heat-dissipation enhancement according to the first embodiment of the present invention;

FIG. 5 is a partially enlarged view of a local heat-dissipation enhancement region of the back plate of FIG. 4 according to the first embodiment of the present invention; and

FIG. 6 is a perspective view of a back plate of the side-light type backlight module with local heat-dissipation enhancement according to a second embodiment of the present invention.

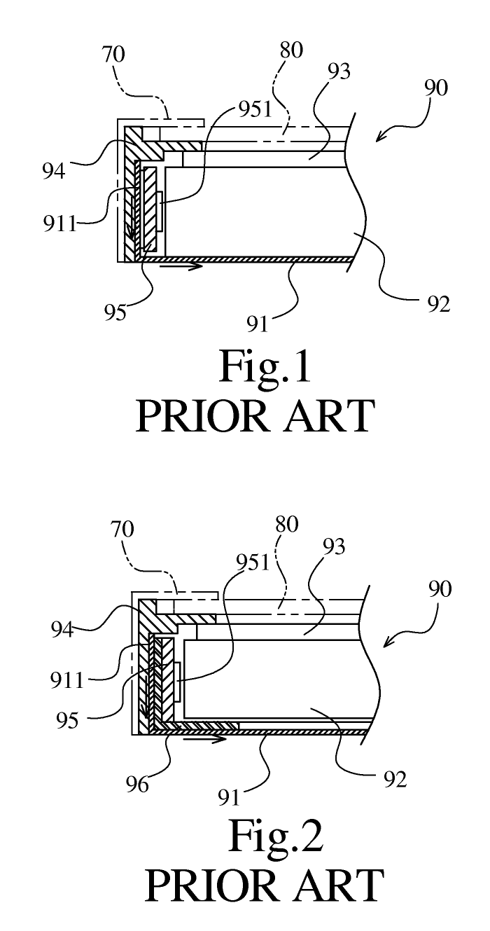

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

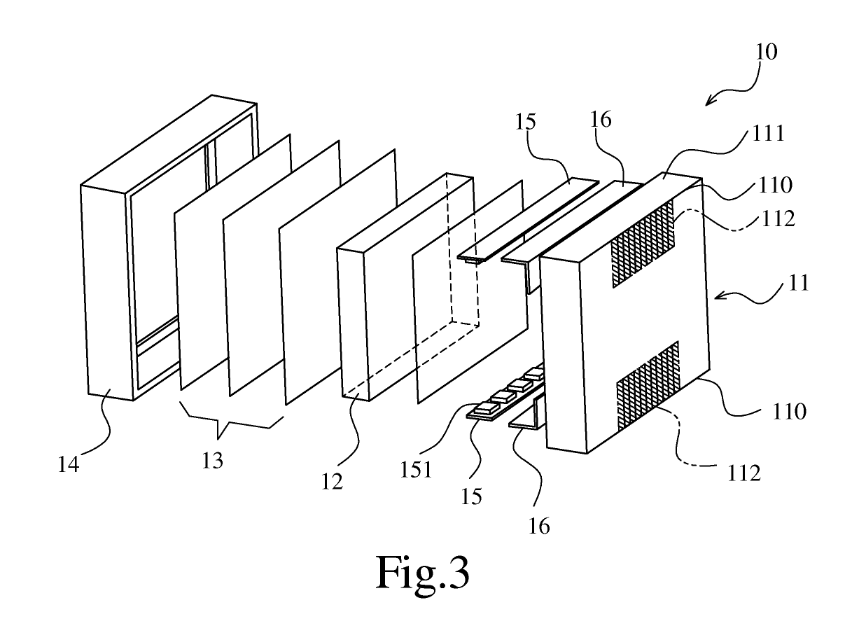

Referring now to FIG. 3, FIG. 3 discloses an exploded perspective view of a side-light type backlight module with local heat-dissipation enhancement according to a first embodiment of the present invention. A side-light type backlight module 10 of the present invention comprises a back plate 11, wherein a central portion of the back plate 11 supports a light guide plate (LGP) 12, and a reflective sheet (unlabeled) is disposed between the back plate 11 and the light guide plate 12. The light guide plate 12 is stacked with an optical film assembly 13 thereon, and a housing 14 is used to mount the optical film assembly 13 and the light guide plate 12 in the back plate 11 from top to bottom. In addition, the side-light type backlight module 10 is further stacked with a liquid crystal panel module, so as to construct a liquid crystal display (LCD) (unlabeled).

Referring to FIG. 3, the side-light type backlight module 10 of the present invention further comprises at least one light source assembly 15. At least one light input side edge 110 of the back plate 11 is vertically extended to form at least one light input side wall 111 (the figure shows two opposite light input side edges 110 and two opposite light input side walls 111), wherein the light input side wall 111 close to the light input side edge 110 has an inner surface mounted with the light source assembly 15, and the light source assembly 15 has at least one light emitting device 151 which can be an LED light emitting device and have a light source direction directing toward the light guide plate 12. The light emitting device 151 is generally mounted on at least one L-shape thermal conductive block 16 by screw connection or thermal conductive tape attachment, and then mounted on the back plate 11. Alternatively, the light emitting device 151 also can be directly mounted on the light input side wall 111. Thus, heat generated by the light source assembly 15 during operation can be transferred to the back plate 11 through the light input side wall 111 of the back plate 11 or the thermal conductive block 16 for dissipating the heat.

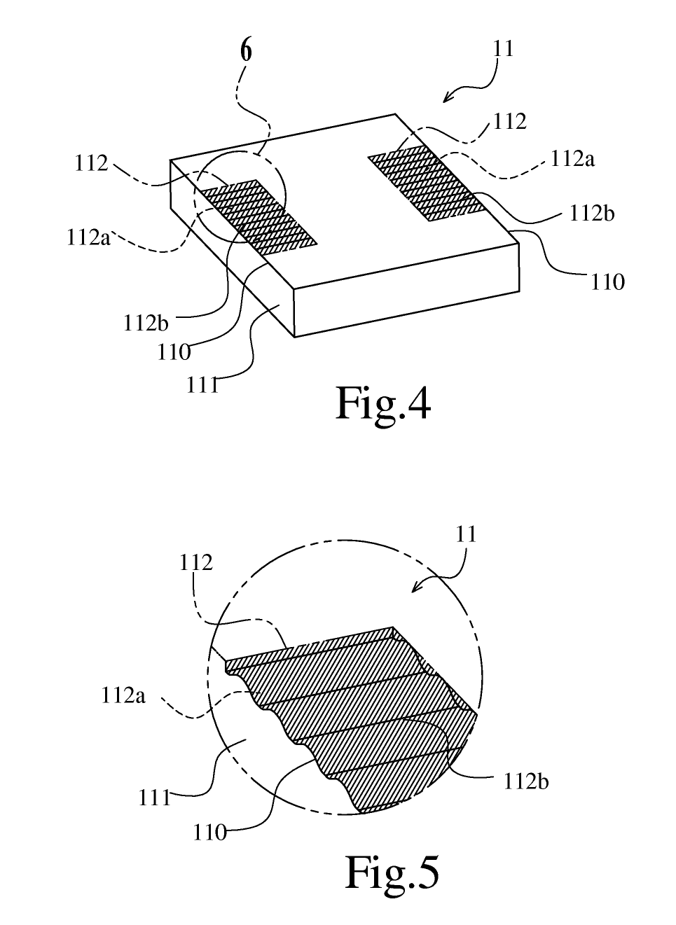

Referring still to FIG. 4, FIG. 4 discloses a perspective view of a back plate of the side-light type backlight module with local heat-dissipation enhancement according to the first embodiment of the present invention. For solving the phenomenon of thermal aggregation described in the background of the invention (i.e. preventing from generating the phenomenon of uneven temperature distribution on the region of the back plate 11 close to the light source assembly 15), a central portion of the back plate 11 close to the at least one light input side edge 110 has a local heat-dissipation enhancement region 112, wherein the a surface of the local heat-dissipation enhancement region 112 has a thermal-conductivity enhancement coating 112a, while the surface of the local heat-dissipation enhancement region 112 has a three-dimensional heat-dissipation profile 112b. The detailed description is disclosed, as follows:

Firstly, there are actually two types of heat transfer modes during dissipating the heat of the side-light type backlight module 10:

(1) heat conduction: the heat dissipated from the light emitting device 151 (LED) is transferred to an inner back surface of the back plate 11 through a printed circuit board (unlabeled) of the light source assembly 15 and/or the thermal conductive block 16, and then transferred to an outer surface of the back plate 11.

(2) heat convection: the heat can be dissipated to the ambient air from the outer surface of the back plate 11 through natural air convection.

Secondly, further referring to various data in the following tables, an initial status and a stable status for lighting the side-light type backlight module 10 (the light emitting device 151) are described, respectively:

Comparison of specific heat capacity, coefficient of thermal conductivity, thermal diffusion coefficient and density between Cu and Al is shown in the following table:

| | coefficient of | | | |
|---|---|---|---|---|
| | thermal | thermal diffusion | specific heat | |
| | conductivity | coefficient | capacity | density |
| material | K(W/mk) | α(10⁻⁶m²/s) | Cp[J/(kg. ° C.)] | ρ(kg/m³) |
| Cu | 401 | 117 | 0.39 × 10³ | 6.4 |
| Al | 237 | 70 | 0.88 × 10³ | 2.7 |

During the heat convection, three parameters for evaluating the speed of the heat convection are listed, as follows:

| evaluation | | representative |
|---|---|---|
| parameter | symbol definition | meaning |
| Nu = h L/k | L: length of fluid size | ratio of convection and |
| | H: convection coefficient; | conduction |
| | surface coefficient | |
| | K: coefficient of thermal | |
| | conductivity | |
| Pr = μCp/k | μ: dynamic viscosity | ratio of dynamic |
| | Cp: specific heat capacity | viscosity and thermal |
| | K: coefficient of thermal | diffusivity |
| | conductivity | Pr = (μ/ρ)/α = |
| | | (μ/ρ)/(k/(ρCp)) = μCp/k |
| Gr = gρ²βL³Δt/μ² | g: acceleration of gravity | ratio of fluid buoyancy |
| | ρ: fluid density | and viscous force |
| | β: coefficient of thermal | |
| | expansion | |
| | L: length of fluid size | |
| | Δt: temperature variation | |
| | μ: dynamic viscosity | |

(1) the initial status for lighting the backlight module 10:

The back plate 11 is generally aluminum (Al) based, and the thermal-conductivity enhancement coating 112a on the surface of the local heat-dissipation enhancement region 112 of the Al-based back plate 11 is preferably coated with copper (Cu) by vacuum sputtering or other methods. Because the thickness of a copper layer (35 μm) is considerably smaller than that of the back plate 11 (generally, 0.8 mm or 1 mm), the thermal resistance generated by the thermal-conductivity enhancement coating 112a (copper coating) can be omitted. The thermal diffusion coefficient of copper is 117×10⁻⁶ m²/s and greater than that of aluminum (70×10⁻⁶ m²/s). Thus, according to the equation α=k/(ρ*C), The dissipated heat of a traditional back plate and a copper coated back plate within the same time is compared with each other, so that the temperature on the local heat-dissipation enhancement region 112 coated with copper can be uniformized more rapidly. If the thermal diffusion coefficient is greater, the speed of heat transferring in material is more rapid, i.e. the temperature can raise more rapidly. In other words, the local heat-dissipation enhancement region 112 coated with copper has a smaller temperature difference in the same direction and the same distance than that of the traditional back plate.

Furthermore, referring now to FIGS. 4 and 5, FIG. 5 discloses a partially enlarged view of a local heat-dissipation enhancement region of the back plate 11 of FIG. 4 according to the first embodiment of the present invention. Factors affecting the surface coefficient (h) comprise the temperature difference, the contact surface area between solid and fluid, and etc. In the first embodiment of the present invention, the copper coating (the thermal-conductivity enhancement coating 112a) of the local heat-dissipation enhancement region 112 can diffuse the heat more rapidly and evenly. In the initial status, the temperature of the local heat-dissipation enhancement region 112 is higher than that of a region on the same position of the traditional back plate, so that the surface coefficient (h) is higher. As shown in FIGS. 4 and 5, except for the thermal-conductivity enhancement coating 112a, the local heat-dissipation enhancement region 112 of the back plate 11 of the present invention further has a three-dimensional heat-dissipation profile 112b, wherein the three-dimensional heat-dissipation profile 112b is preferably wavy, and the wavy design can increase the heat exchange area of the local heat-dissipation enhancement region 112, so that the temperature can rapidly diffused into the ambient air through natural air convection. Due to the considerable increase of the surface area, the surface coefficient (h) is increased too, so that the evaluation parameter (Nu) is increased. According to the definition of (Nu), the convection will be enhanced.

Similarly, in the initial status, the temperature difference between the local heat-dissipation enhancement region 112 coated with copper and the ambient air is greater than that between the traditional back plate and the ambient air. Thus, if the (Δt) is increased, the (Gr) will be higher, i.e. the ratio of fluid buoyancy and viscous force will be greater. It describes that the buoyancy of hot air surrounding the local heat-dissipation enhancement region 112 is increased, so that it is advantageous to generate the natural air convection to raise the hot air and lower the cool air for exchanging the heat. Thus, the heat can be dissipated outside more rapidly.

(2) the stable status after lighting the backlight module 10 a period of time:

The local heat-dissipation enhancement region 112 can accelerate the convection type heat dissipation, so that the temperature of the back plate 11 can be lowered down, the evaluation parameters (Nu) and (Gr) generated due to the temperature difference will be reduced, and the natural air convection will be weakened, until the backlight module 10 and the ambient air reach a stable status, i.e. heat generated by LEDs is equal to heat dissipated by air convection. At this time, not only the temperature of the back plate 11 is evenly distributed, but also the average temperature thereof is lower than that of the traditional back plate. Thus, it is advantageous to even the light output, the chromaticity of LEDs, and enhance the light extraction efficiency thereof.

As described above, the local heat-dissipation enhancement region 112 has the copper coating (i.e. the thermal-conductivity enhancement coating 112a) having a thermal diffusion coefficient greater than that of aluminum, the temperature thereof can be rapidly distributed to an even degree within the copper coating region. Because the copper coating can enhance the natural air convection, the temperature of the local heat-dissipation enhancement region 112 of the back plate 11 and its neighbor regions will be lowered down. In such a way, the final temperature of the light emitting devices 151 (LEDs) on different positions of the light source assembly 15 will be lowered and reach an even degree, while the brightness of the light emitting devices 151 on different positions of the light source assembly 15 will be more even and the chromaticity thereof will be more even too. Thus, the uniformity of the brightness and the chromaticity of the entire liquid crystal display will be enhanced. Furthermore, the final temperature of the light emitting devices 151 is lowered down, so that the light extraction efficiency thereof can be enhanced.

Moreover, in the present invention, the material of the thermal-conductivity enhancement coating 112a is not limited. Except for copper coating, the material of the thermal-conductivity enhancement coating 112a also can be other coating which has a thermal diffusion coefficient greater than that of the back plate 11.

Besides, in the present invention, the shape of the three-dimensional heat-dissipation profile 112b is not limited. Except for wavy shape, the three-dimensional heat-dissipation profile 112b also can be other outline capable of increasing the surface area to provide assistant heat dissipation, such as fin-like.

In addition, although the first embodiment of the present invention discloses that the surface of the local heat-dissipation enhancement region 112 simultaneously has the thermal-conductivity enhancement coating 112a and the three-dimensional heat-dissipation profile 112b, the present invention is not limited thereto. In the present invention, a user can selectively use one of the technical features according to actual needs for carrying out a certain heat dissipation effect. For example, the surface of the local heat-dissipation enhancement region 112 has the thermal-conductivity enhancement coating 112a but does not have the three-dimensional heat-dissipation profile 112b; or the surface of the local heat-dissipation enhancement region 112 has the three-dimensional heat-dissipation profile 112b but does not have the thermal-conductivity enhancement coating 112a.

Furthermore, in the present invention, the occupation ratio of the local heat-dissipation enhancement region 112 in relation to the back plate 11 is not limited, the user can vary according to actual needs. For example, according to a central concept of an object and a desired basic effect thereof, the length of the local heat-dissipation enhancement region 112 can be designed to be equal to or greater than one-third of the length of the at least one light input side edge 110. Moreover, the width of the local heat-dissipation enhancement region 112 (the other direction relative to the length) can be equal to or greater than one-fourth of the width of the back plate 11.

Besides, the at least one light input side edge 110 of the back plate 11 can be vertically extended (integrally or not integrally) to form at least one light input side wall 111, and the local heat-dissipation enhancement region 112 can be extended onto the at least one light input side wall 111 (not-shown).

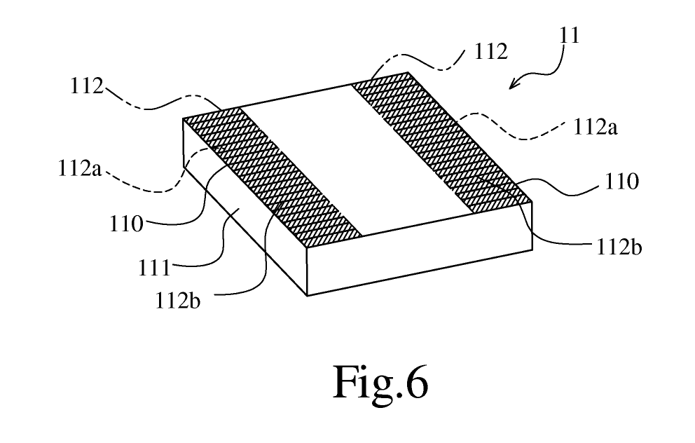

Referring now to FIG. 6, FIG. 6 discloses a perspective view of a back plate of the side-light type backlight module with local heat-dissipation enhancement according to a second embodiment of the present invention. The local heat-dissipation enhancement region 112 of the back plate 11 of the second embodiment of the present invention is similar to the local heat-dissipation enhancement region 112 of the first embodiment, so that the second embodiment uses similar numerals and element names of the first embodiment, but the difference of the second embodiment is that: the length of the local heat-dissipation enhancement region 112 is equal to the full length of the at least one light input side edge 110, i.e. the local heat-dissipation enhancement region 112 occupies the entire side of the back plate 11 close to the at least one light source assembly 15. In this design, the local heat-dissipation enhancement region 112 on different positions has the same active function of heat conduction and heat convection. Thus, although the temperature distribution of the back plate 11 is still uneven, the entire temperature of the back plate 11 can be lowered down due to the thermal-conductivity enhancement coating 112a of the local heat-dissipation enhancement region 112 for enhancing the heat convection. As a result, the final temperature of the light emitting device 151 can be efficiently lowered down, and the light extraction efficiency thereof can be enhanced.

As described above, in comparison with the traditional side-light type backlight module which has a region of the back plate close to the light input side edge to cause a phenomenon of uneven temperature distribution (i.e. a relatively central portion of this region has a higher temperature, and two relatively edge portions thereof has a lower temperature) during dissipating heat and thus cause the uneven chromaticity and brightness of the light emitting device and the uneven brightness and chromaticity of the entire liquid crystal display, the present invention discloses that a central position of the back plate 11 close to the at least one light input side edge 110 is provided with the local heat-dissipation enhancement region 112, and the surface of the local heat-dissipation enhancement region 112 has the thermal-conductivity enhancement coating 112a and the three-dimensional heat-dissipation profile 112b. The thermal-conductivity enhancement coating 112a has a greater thermal diffusion coefficient to rapidly distribute the temperature to an even degree, while the three-dimensional heat-dissipation profile 112b can increase the heat exchange area, so that the temperature can be rapidly diffused into the ambient air through natural air convection. Thus, the side-light type backlight module with local heat-dissipation enhancement of the present invention can efficiently ensure the chromaticity and brightness of the light emitting device, so as to improve the uniformity of the chromaticity and brightness of the entire liquid crystal display (LCD) module and enhance the light extraction efficiency thereof.

The present invention has been described with a preferred embodiment thereof and it is understood that many changes and modifications to the described embodiment can be carried out without departing from the scope and the spirit of the invention that is intended to be limited only by the appended claims.

1. A side-light type backlight module with local heat-dissipation enhancement, the side-light type backlight module comprising a back plate and at least one light source assembly, the back plate having at least one light input side edge, and the at least one light source assembly being close to the at least one light input side edge, characterized in that: a central portion of the back plate close to the at least one light input side edge is formed with a local heat-dissipation enhancement region; a surface of the local heat-dissipation enhancement region has a thermal-conductivity enhancement coating and a three-dimensional heat-dissipation profile; and material of the thermal-conductivity enhancement coating has a thermal diffusion coefficient greater than that of base material of the back plate.

2. The side-light type backlight module with local heat-dissipation enhancement according to claim 1, characterized in that: material of the thermal-conductivity enhancement coating has a thermal diffusion coefficient greater than that of base material of the back plate.

3. The side-light type backlight module with local heat-dissipation enhancement according to claim 1, characterized in that: the thermal-conductivity enhancement coating is a copper coating; the base material of the back plate is aluminum or alloy thereof.

4. The side-light type backlight module with local heat-dissipation enhancement according to claim 1, characterized in that: the three-dimensional heat-dissipation profile is wavy or fin-like.

5. The side-light type backlight module with local heat-dissipation enhancement according to claim 1, characterized in that: the length of the local heat-dissipation enhancement region is equal to or greater than one-third of the length of the light input side edge.

6. A side-light type backlight module with local heat-dissipation enhancement, the side-light type backlight module comprising a back plate and at least one light source assembly, the back plate having at least one light input side edge, and the at least one light source assembly being close to the at least one light input side edge, characterized in that: a portion of the back plate close to the at least one light input side edge is formed with a local heat-dissipation enhancement region; a surface of the local heat-dissipation enhancement region has a thermal-conductivity enhancement coating.

7. The side-light type backlight module with local heat-dissipation enhancement according to claim 6, characterized in that: material of the thermal-conductivity enhancement coating has a thermal diffusion coefficient greater than that of base material of the back plate.

8. The side-light type backlight module with local heat-dissipation enhancement according to claim 7, characterized in that: the thermal-conductivity enhancement coating is a copper coating; the base material of the back plate is aluminum or alloy thereof.

9. The side-light type backlight module with local heat-dissipation enhancement according to claim 6, characterized in that: the surface of the local heat-dissipation enhancement region has a three-dimensional heat-dissipation profile.

10. The side-light type backlight module with local heat-dissipation enhancement according to claim 9, characterized in that: the three-dimensional heat-dissipation profile is wavy or fin-like.

11. The side-light type backlight module with local heat-dissipation enhancement according to claim 6, characterized in that: at least a central portion of the back plate close to the light input side edge has the local heat-dissipation enhancement region.

12. The side-light type backlight module with local heat-dissipation enhancement according to claim 6, characterized in that: the length of the local heat-dissipation enhancement region is equal to or greater than one-third of the length of the light input side edge.

13. A side-light type backlight module with local heat-dissipation enhancement, the side-light type backlight module comprising a back plate and at least one light source assembly, the back plate having at least one light input side edge, and the at least one light source assembly being close to the at least one light input side edge, characterized in that: a portion of the back plate close to the at least one light input side edge is formed with a local heat-dissipation enhancement region; a surface of the local heat-dissipation enhancement region has a three-dimensional heat-dissipation profile.

14. The side-light type backlight module with local heat-dissipation enhancement according to claim 13, characterized in that: the three-dimensional heat-dissipation profile is wavy or fin-like.

15. The side-light type backlight module with local heat-dissipation enhancement according to claim 13, characterized in that: the surface of the local heat-dissipation enhancement region has a thermal-conductivity enhancement coating; and material of the thermal-conductivity enhancement coating has a thermal diffusion coefficient greater than that of base material of the back plate.

16. The side-light type backlight module with local heat-dissipation enhancement according to claim 15, characterized in that: the thermal-conductivity enhancement coating is a copper coating; the base material of the back plate is aluminum or alloy thereof.

17. The side-light type backlight module with local heat-dissipation enhancement according to claim 13, characterized in that: at least a central portion of the back plate close to the light input side edge has the local heat-dissipation enhancement region.

18. The side-light type backlight module with local heat-dissipation enhancement according to claim 13, characterized in that: the length of the local heat-dissipation enhancement region is equal to or greater than one-third of the length of the light input side edge.
